(19) United States
(12) Patent Application Publication
(10) Pub. No.: US 2011/0251974 A1
(43) Pub. Date: Oct. 13, 2011

(54) SYSTEM AND METHOD FOR UTILIZING SENTIMENT BASED INDICATORS IN DETERMINING REAL PROPERTY PRICES AND DAYS ON MARKET

(76) Inventors: Scott E. Woodard, Clarendon Hills, IL (US); Depeng Bi, Buffalo Grove, IL (US)

(21) Appl. No.: 12/755,472

(22) Filed: Apr. 7, 2010

(51) Int. Cl. G06Q 50/00; G06F 17/30; G06Q 10/00

(52) U.S. Cl. 705/348; 707/705; 707/E17.001

(57) ABSTRACT

A system and method for estimating the final sales price and amount of time required to sell a newly listed property based on the number of viewings that the property receives within a predetermined time of the properties listing. A model is constructed based on comparable properties, and the number of viewings that the newly listed property receives within the predetermined time period is compared to the number of viewings that properties within the model set received within the same time period after their respective listings. On-market days and percent of listing price are derived from this model.

### FIELD OF THE INVENTION

The present invention relates generally to a system and method for determining the time a property will be on the market given a certain price, and vice versa, and is particularly directed to a system and method for determining the time a property will be on the market at a certain price based on the number of showings the property receives within a number of days after being listed, the number of web site viewings that the property receives within a predetermined time period, such as week, after being listed, and other similar factors. In the same manner, an approximation of a likely sale price for a desired on-market time can be determined.

### DESCRIPTION OF THE PRIOR ART

Listing a property at an appropriate price and adjusting the price based on the realities of the marketplace are arguably the most important factors in quickly selling or leasing a real property for a price approximating the market price. Properties that linger on the market are viewed with suspicion by prospective buyers, and, if listed for a long enough period, can often only be sold at a steep discount. There are numerous prior art approaches to determining an appropriate price for real property. Nearly all approaches to pricing real property require a description of the real property. For example, a residential property may include in its description the address, the number of bedrooms, the number of bathrooms, whether the property has an attached garage, the number of cars the garage will hold, the size of the lot, and any special features of the property, such as whether the property has an in-ground pool. In addition, other factors are used to price real property. Some commonly used factors are the location of the property with regards to the neighborhood that the property is in, the price that recently sold comparables went for, the date and time that the listing was commenced, favorable or unfavorable zoning, the quality of public and private schools available to the property for residential properties, proximity to desirable facilities, such as railway yards for manufacturing properties, banking centers for commercial properties, and shopping malls for residential properties. All of these factors provide useful guidelines for pricing a property so that it quickly garners a market price.

Nonetheless, traditional real property pricing systems and methods do not account for the fact that certain properties, while having desirable descriptions, and meeting the requirements of a desirable property, do not sell as fast as other properties having similar descriptions, or gather as high a price as other properties having similar descriptions. The state of the art in real property pricing systems presently leaves this to the discretion of the real estate agent listing the property. However, present systems provide little guidance to a real estate agent that a property is improperly listed; generally, if the property has not sold within several months, the real estate agent will discuss lowering the price with the owner of the property. Accordingly, there is a need to provide timely feedback to real property sellers to detect a property that is improperly listed as quickly as possible, so that its price can be adjusted, and it can be sold as quickly as possible for a reasonable price.

### OBJECTS OF THE INVENTION

Accordingly, it is an object of this invention to provide a system and method for quickly determining if a property has been priced inappropriately.

Another object of this invention is to utilize sentiment based indicators to determine the expected time that a property will be on the market.

Another object of this invention is to utilize sentiment based indicators to determine the likely sale price that a newly listed property is likely to receive based on sentiment based indicators.

Other advantages of the disclosed invention will be clear to a person of ordinary skill in the art. It should be understood, however, that a system or method could practice the disclosed invention while not achieving all of the enumerated advantages, and that the protected invention is defined by the claims.

### SUMMARY OF THE INVENTION

Accordingly it is an advantage of the present invention to provide a method for accurately estimating the number of days that a real property is likely to be on market before a transaction occurs. Generally, the premise of the disclosed method is that the number of viewings that a property receives within a time period after its listing is predictive of the number of days that will be required to sell the property and the percentage of the listing price for which the property will sell.

In a first embodiment, the method analyzes a particular real property that is listed at a particular price, and which has been viewed a measured number of times during a time period after its listing. The method begins by analyzing a listing and sales database that contains transaction information corresponding to a plurality of real property listings with similar characteristics to the real property for which an estimate is to be generated (“newly listed property”). Using the database a model is derived that relates the number of viewings that a property receives within a time period after its listing to the percentage of the listing price that the property eventually sold for, as well as the number of on-market days that the property took to sell. The number of viewings the newly listed property received within a time period after its listing is then applied to the model to arrive at an estimate of the number of on-market days which the property will be listed prior to its sale as well as an estimate of the percentage of the listing price that the property will receive.

The time period during which the initial viewings are measured can beneficially be set to any period from several hours to several days, and up to a week, several weeks, or somewhat longer. A non-inclusive list of characteristics that can be used to filter a database of real property transactions to a set that can be used to generate meaningful estimates of the on-market days and percent of listing price for a real property include: geographical factors, such as the location of the property, the distance of the property from schools, malls, banks, etc.; physical factors, such as square feet, number of bedrooms, number of baths, lot size, size of rooms, layout of rooms, etc.; and the quality of local services, such as schools, fire, police, etc.

A further refinement of this embodiment derives the estimation model using a simple best fit exponential trendline analysis or other more complex regression or other statistical models. In yet another refinement of this embodiment, web sites associated with at least some of the real properties within the listing and sales database are accessed, and the number of viewings that the websites received within a period of the corresponding real properties being listed for sale are used in deriving the estimation model. Other refinements can include the use of monitored lockboxes and key kiosks.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a diagram of a system that can implement the disclosed real property sales price and on-market day estimation method;

FIG. 2 is a flowchart depicting a method for selecting properties for use with the on-market days and price estimation method disclosed herein using the surrounding area and certain physical characteristics of the newly listed property;

FIG. 3 is a flowchart depicting a method for selecting properties for use with the on-market days and price estimation method disclosed herein using the school district, listing date, and listing price of the newly listed property;

FIG. 4 is a flowchart depicting a method of applying a real estate on-market day and pricing model to a newly listed property;

FIG. 5 is a flowchart depicting a method of deriving an on-market days and pricing model for a newly listed property based on a collection of comparable properties;

FIG. 6 is a data table constructed in accordance with the methodology of FIG. 5, and containing data for forecasting the number of on-market days for a real property based on the number of showings that the property received within 1 day after being listed;

FIG. 7 is a chart based on the data table of FIG. 6, depicting the number of viewings that occurred within seven days of listing for a pool of properties versus the number of on-market days experienced by the 10% of properties that sold after the least number of on-market days for the number of viewings, and the 10% of properties that sold after the most number of on-market days for the number of viewings;

FIG. 8 is a chart based on the data table of FIG. 6, depicting the number of viewings that occurred within one day of listing for a pool of properties versus the number of on-market days experienced by the 10% of properties that sold after the least number of on-market days for the number of viewings, and the 10% of properties that sold after the most number of on-market days for the number of viewings;

FIG. 9 is a data table constructed in accordance with the methodology of FIG. 5, and containing data for forecasting the sales price ratio, i.e., the percent of listing price that a property is expected to receive, versus the number of showings the property received within the a day of its listing;

FIG. 10 is a chart based on the data table of FIG. 9, depicting the expected sales price ratio for a newly listed property versus the number of viewings of a newly listed property that occurred within one day of its listing;

FIG. 11 is a chart based on the data table of FIG. 9, depicting the number of viewings that occurred within a day of listing for a pool of properties versus the sales price ratio received by the 10% of properties that received the highest sales price ratio and the sales price ratio received by the 10% of properties that received the lowest sales price ratio;

FIG. 12 is a data table constructed in accordance with the methodology of FIG. 5 and containing data for forecasting the number of on-market days for a real property based on the number of showings that the property received within seven days after being listed;

FIG. 13 is a chart based on the data table of FIG. 12, depicting the number of viewings that occurred with seven days of listing for a pool of properties versus the number of median on-market days that a newly listed property with a similar number of viewings can expect before selling;

FIG. 14 is a chart based on the data table of FIG. 12, depicting the number of viewings that occurred within seven days of listing for a pool of properties versus the number of on-market days experienced by the 10% of properties that sold after the least number of on-market days for the number of viewings, and the 10% of properties that sold after the most number of on-market days for the number of viewings;

FIG. 15 is a data table constructed in accordance with the methodology of FIG. 5, and containing data for forecasting the sales price ratio, i.e., the percent of listing price that a property is expected to receive, versus the number of showings the property received within seven days of its listing;

FIG. 16 is a chart based on the data of FIG. 15 depicting the expected sales price ratio for a newly listed property versus the number of viewings of a newly listed property that occurred within seven days of its listing; and

FIG. 17 is chart based on the data of FIG. 15 depicting the number of viewings that occurred within seven days of listing for a pool of properties versus the sales price ratio received by the 10% of properties that received the highest sales price ratio and the sales price ratio received by the 10% of properties that received the lowest sales price ratio.

### DETAILED DESCRIPTION

Another embodiment of the disclosed invention provides an estimate of the number of on-market days before a newly listed property will sell, as well as an estimate of the percentage of listing price that the newly listed property is likely to receive. The disclosed system and method utilize the number of viewings that the newly listed property receives in a predetermined time period after listing along with a model constructed from past transactions of similar properties to estimate how long the newly listed property will take to sell as well as how much the newly listed property will sell for. A number of the previously disclosed improvements, including the key kiosk tracking system and the lockbox matching system, can be advantageously utilized with the disclosed estimation system and method, as explained herein.

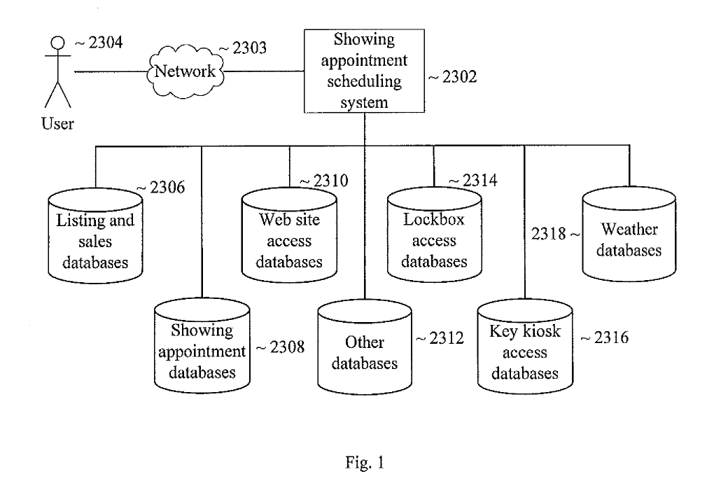

FIG. 1 depicts a system on which the disclosed method can be implemented. A user 2304 accesses a showing appointment scheduling system 2302 using a network 2303. The showing appointment scheduling system 2302 can access one or more listing and sales databases 2306, one or more showing appointment databases 2308, one or more web site access databases 2310, one or more lockbox access databases 2314, one or more key kiosk access databases 2316, one or more weather databases 2318, and one or more other types of databases 2312.

As explained further herein, the showing appointment scheduling system 2302 utilizes the listing and sales databases 2306 to assemble a model set of comparable properties on which the divulged sentiment analysis is performed. The showing appointment databases 2308, web site access databases 2310, lockbox access databases 2314, and key kiosk access databases 2316 are used to gauge the interest that members of the public have in a particular property.

Weather databases 2318 are used to normalize the interest data. Generally, shoppers will schedule fewer viewings on bad-weather days, i.e., colder than average days, exceptionally hot days, or days with heavy precipitation. To account for such periods that properties within the model set were on the market, bad weather days can be assigned a lower weighting, or the data normalized to account for the bad weather using another method known within the field of statistical analysis.

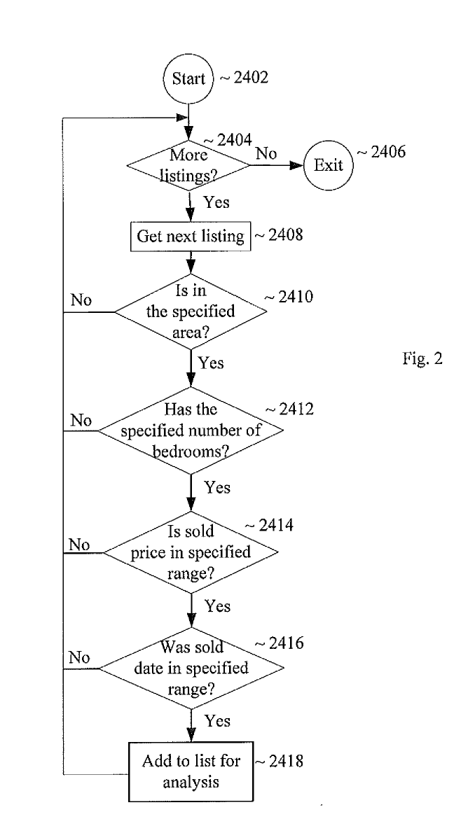

FIG. 2 depicts a flowchart for selecting a set of properties for use in deriving a model that will accurately estimate the on-market days and selling price for a newly listed property. The method is intended to be implemented on a computer having access to a listing and sales database containing transaction information, i.e., a description of the property including address, physical description, etc., as well as the date the property was listed, the property's initial listing price, the number of days the property was on the market, and the properties selling price; for a plurality of properties. As will be apparent to those of skill in the art a larger sample of properties will provide more accurate estimates, and a model set can be constructed using only a part of the referenced information, i.e., the physical characteristics of the property are not required to build a model set on which the disclosed predictive methods can be effectively applied. The method is entered in step 2402 at which point a record iterator is initialized. In step 2404 the iterator is checked to determine if there are more property records in the database, and if not, execution transitions to step 2406, where the method is exited. However, if additional property records are available, execution transitions to step 2408, where the next property record is retrieved. In step 2410, the property record is examined to determine if the property is located in the same area as the newly listed property. If so, the property is a candidate for inclusion in the set of properties that are to be used to construct an estimation model for use with the newly listed property (“model set”). Execution then transitions to step 2410. If not, execution transitions to step 2404, where the iterator is iterated, and checked for additional property records.

In step 2412, the property record is examined to determine if the property has comparable characteristics as the newly listed property, such as, for example, the same number of bedrooms as the newly listed property. If not, execution transitions to step 2404. However, if so, the property is maintained as a candidate for inclusion in the model set and execution transitions to step 2414. In step 2414, the property record is checked to determine if the referenced property sold within the specified price range; i.e., the estimated sales price of the newly listed property as determined by, for example, a trained real estate agent. If not, execution transitions to step 2404. However, if so, execution transitions to step 2416. If not, execution transitions to step 2404. However, if so, the property is suitable for inclusion within the model set, and is added to the model set. Execution then transitions to step 2404.

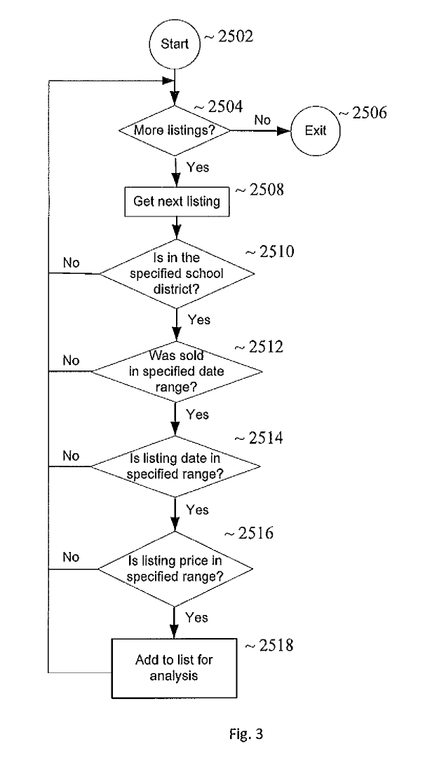

FIG. 3 depicts a flowchart for selecting a set of properties for use in deriving a model that will accurately estimate the on-market days and selling price for a newly listed property. The method is intended to be implemented on a computer having access to a listing and sales database containing transaction information, i.e., a description of the property including address, the school district the property is closest to, the date the property was sold, the date the property was listed, the listing price, etc.; for a plurality of properties. The method is entered in step 2502 at which point a record iterator is initialized. In step 2504 the iterator is checked to determine if there are more property records in the database, and if not, execution transitions to step 2506, where the method is exited. However, if additional property records are available, execution transitions to step 2508, where the next property record is retrieved. In step 2510, the property record is examined to determine if the property is in the specified school district. If not, execution transitions to step 2504. If so, the property is a candidate for inclusion in the model set, and execution transitions to step 2512. In step 2512, the property record is examined to determine if the property was sold in the specified date range. If not, execution transitions to step 2504. If so, the property is maintained as a candidate for inclusion in the model set, and execution transitions to step 2514.

In step 2514, the property record is examined to determine if the listing date is within a specified date range, such as, for example, the same date that the newly listed property is being listed, but one year earlier. This factor is included to account for seasonal variations in shopper interest, as well as seasonal variations in on-market days and received price. If the property record is not within the specified date range, execution transitions to step 2504. If so, the property record is within the specified date range, the property is maintained as a candidate for inclusion in the model set, and execution transitions to step 2516. In step 2516, the property record is checked to determine if the listing price is within the specified range. If not, execution transitions to step 2504. However, if the property record indicates that the listing price was within the specified range, the property is suitable for inclusion within the model set, and is added thereto. Execution then transitions to step 2504.

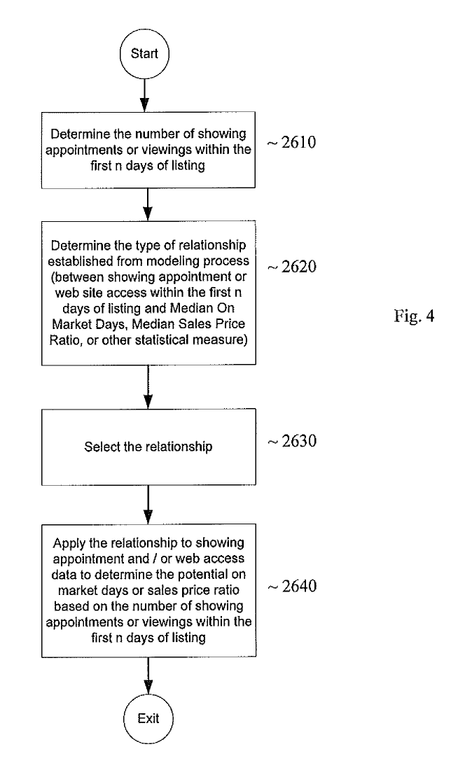

FIG. 4 is a flowchart describing how to apply a model constructed in accordance with this disclosure to a newly-listed property. As explained herein, a model is constructed using products that are filtered on a number of characteristics to produce a set of comparable properties that can be used to accurately forecast the number of on-market days for a newly-listed property as well as the percent of listing price that the newly-listed property will sell for. In step 2610 the number of viewings the newly-listed property received within n days of listing is recorded. In step 2620, the type of relationship established by the modeling process Is noted; i.e., on-market days, percent of listing price, etc. In step 2630, the relationship is selected, and, in step 2640, the relationship predicted by the model is forecast by applying the number of viewings within the first day recorded in step 2610 to the model.

A further refinement of the method of FIG. 4 would be to adapt the value of n based on the number of matching records so that at least a minimum number of records would be included within a range of n values. For example, instead of attempting to establish a relationship from 1-3 properties, each of which received 25 viewings within the first day of being listed, the algorithm could be run again to assemble a set of properties that received 25 viewings within two days of being listed. Those properties would then be grouped and a relationship established from those properties according to the remaining steps of the method.

Persons of skill in the field of real property sales will understand that the number of viewings within different periods may be captured and used with the forecasting model, as long as the forecasting model is adjusted accordingly. For example, the number of viewings within 12 hours of the properties listing may be used as long as the number of viewings within 12 hours of listing are recorded within the records for the comparable properties within the model set, and the model is constructed using the number of viewings within 12 hours of listing.

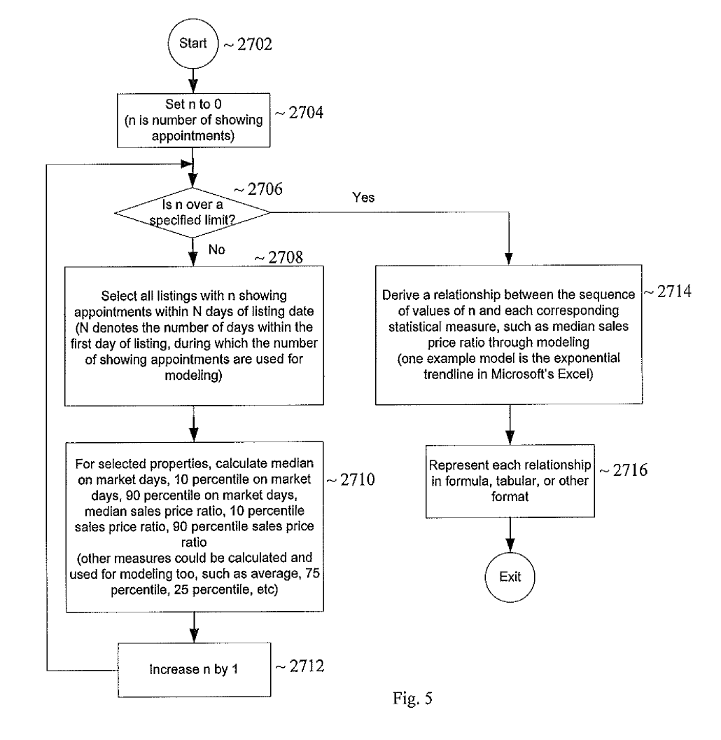

FIG. 5 is a flowchart describing how a forecasting model can be constructed from a database of transaction and property records to forecast the number of on-market days or the expected sales price as compared to listing price for a newly listed property. In step 2702, the method is entered. In step 2704, a counter is initialized to zero; this counter tracks a certain number of viewings that must have occurred within a specified viewing period. In step 2706, the counter is checked to see if it is beyond the number of viewings that the model builder specified. If the counter is not beyond the number of viewings that the model builder specified, execution then transitions to step 2708, where all comparable listings with at least n showings within a time period N of being listed are selected. In this case, N denotes a fixed time period, such as 7 or 21 days, while n denotes a number of actual showings and/or web viewings. Execution then transitions to step 2710 where a number of quantities for the selected properties are calculated; the number of on-market days for the 10% of properties that sold the fastest (10% on-market days), the number of on-market days for the 10% of properties that took the long the longest to sell (90% on-market days), the percentage of listing price for the 10% of properties that received the lowest percentage of listing price (10% sales price ratio), the percentage of listing price received by the 10% of properties that received the highest percentage of listing price (90% sales price ratio), the median number of on-market days, and any other measures that are to be modeled. Calculation of these quantities is well-known in the art, and will not be discussed further herein. The counter n, which is the number of showing appointments that a property received within a time period N of being listed, is increased by one, and execution returns to step 2706.

During execution of step 2706, the counter n is checked to determine if it is over the specified limit, and if so, execution transitions to step 2714. During execution of step 2714, a relationship between the sequence of values of n, i.e., the number of showings that a property received within a time period N after being listed, and one or more desired statistical measures is derived. The desired statistical measures can include, for example, the number of expected on-market days, or the expected percentage of listing price that the newly-listed property will receive. In step 2716, the modeled relationship is represented in a form that it can be used, such as in a formula, table, or graph. Several specific examples are examined in FIGS. 28-39 and the following description.

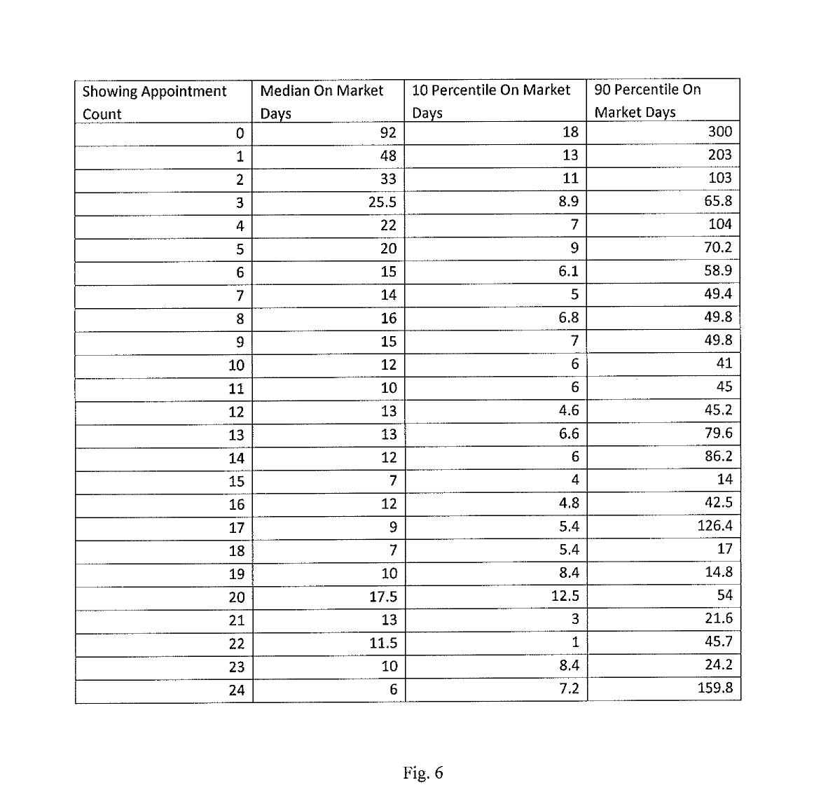

FIG. 6 depicts a table relating the number of showings that a property receives within the first day of its listing to the expected number of on-market days. Focusing on row 3, it is apparent that a property within the model group that was viewed 3 times within the first day of its listing was on the market for a median time of 25.5 days, with the 10% selling fastest being on the market for 8.9 days, and the 10% that took the longest to sell being on the market for 65.8 days. The predictive efficacy of this approach is also apparent; as the number of viewings within the first day increased, the median on-market days steadily decreases, with the predictive ability declining somewhat for properties that experience more than 9 viewings within the first day of listing.

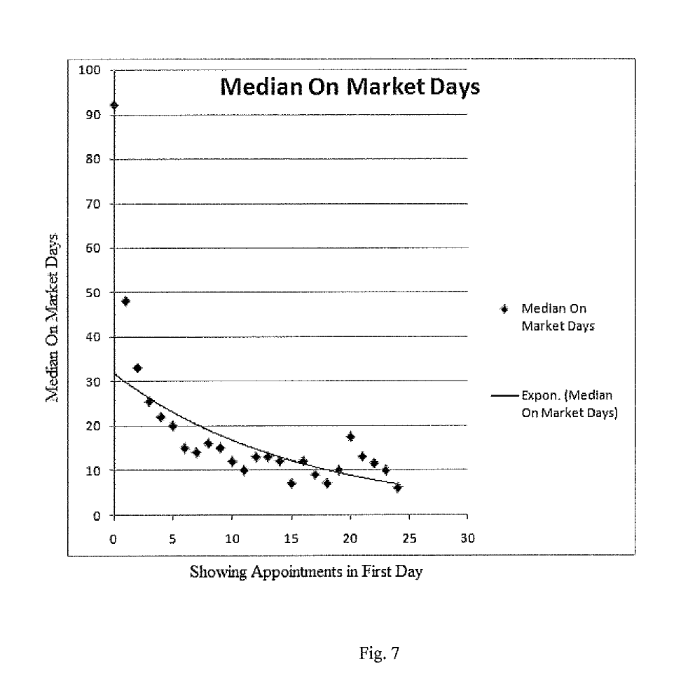

FIG. 7 is a graph using the data from the table of FIG. 6 depicting the number of viewings that a property received within the first day versus the median on-market days that the property required to sell. It is readily apparent that, generally, a property that experiences more viewings within the first day of listing will sell faster than an equivalent property. To account for some of the aberrant readings when making a prediction, a data-fitting method can be used. Many such methods, such as simple trend lines, or the exponential trend line depicted in FIG. 7 are known in the art, and will not be discussed further here.

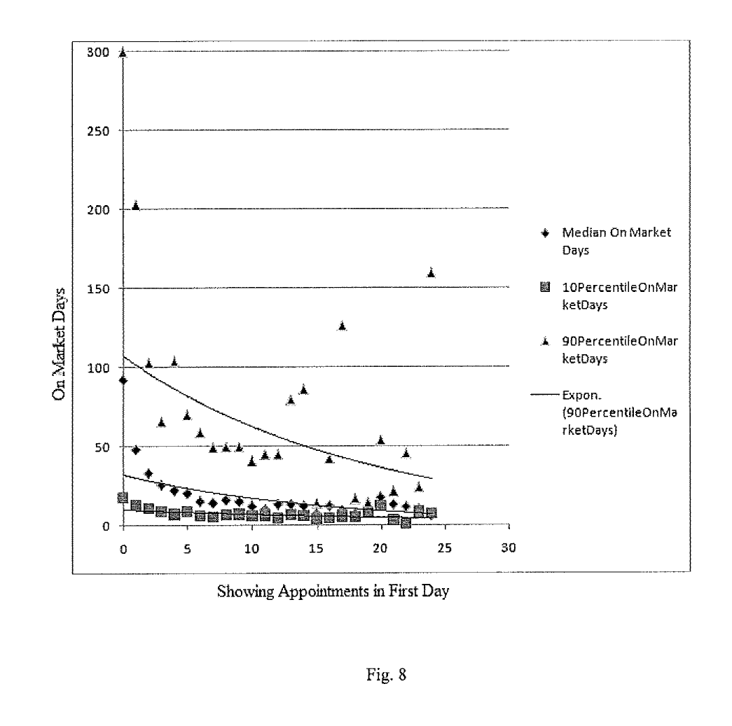

FIG. 8 is an additional graph of the data from the table of FIG. 6 depicting the number of viewings that a property received within the first day versus the median on-market days, as well as the 10% of properties that sold most rapidly and the 10% of properties that required the most time to sell. As with the previous figure, exponential trend lines are used to fine tune predictions.

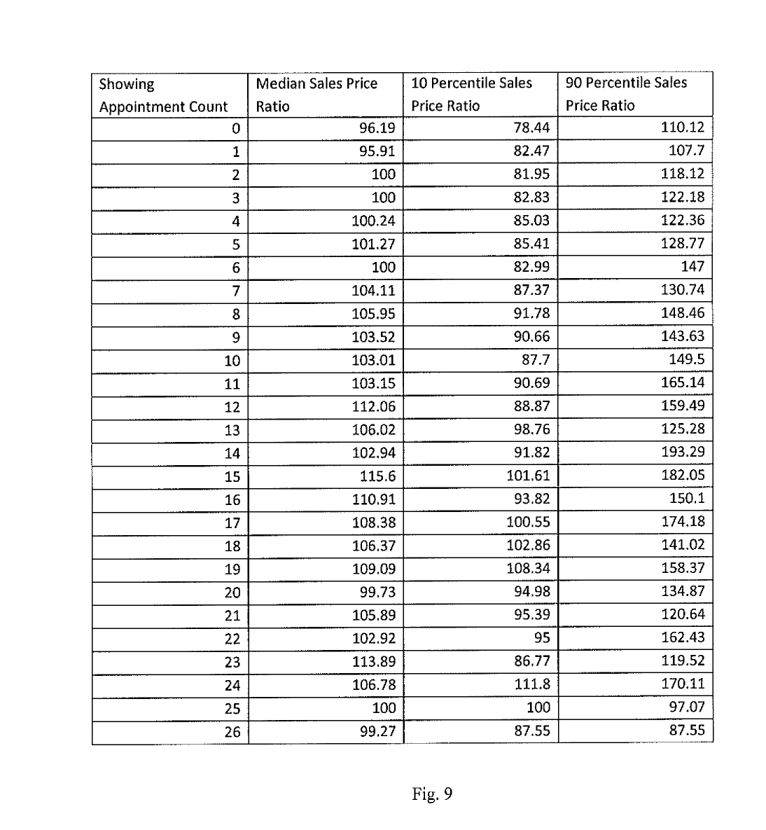

FIG. 9 is a data table relating the number of showings that a property receives within the first day of its listing to the expected median sales price ratio, i.e., the percentage of listing price, that a newly listed property can expect to sell for. Looking at the data table in more detail, a newly listed property that experiences 3 viewings within a day of listing can expect a median sales price ratio of 100%, although the sales price for the 10% of properties that experienced a similar number of viewings and sold for the least was 82.83% of listing price, and the sales price for the 10% of properties that experienced a similar number of viewings and sold for the most was 122.18%. It is apparent from the data that, for the properties that comprised the model set, properties that received a greater number of viewings within one day also received a greater percentage of listing price.

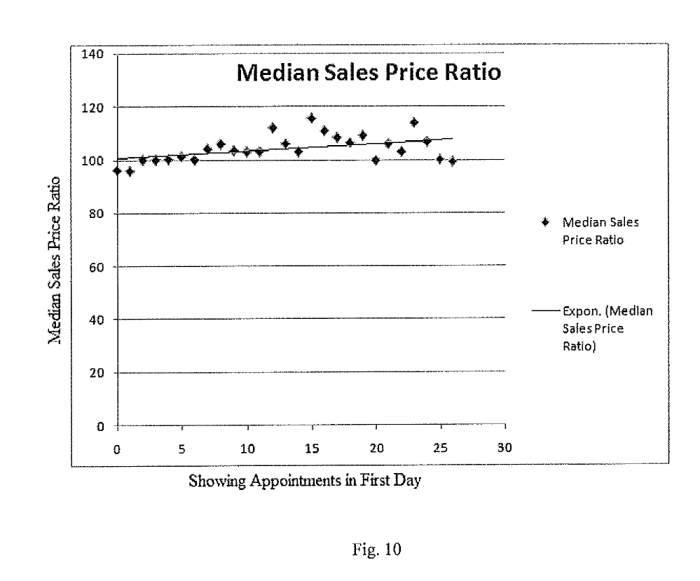

FIG. 10 is a graph created using the data from the table of FIG. 9 depicting the median sales price ratio that a newly listed property can expect to receive based on the number of viewings that the newly listed property receives within one day of listing. As with the other graphs, to fine tune projections, a best fit algorithm, such as an exponential trendline as illustrated, is used to actually project the median sales price ratio that a newly listed property can be expected to receive.

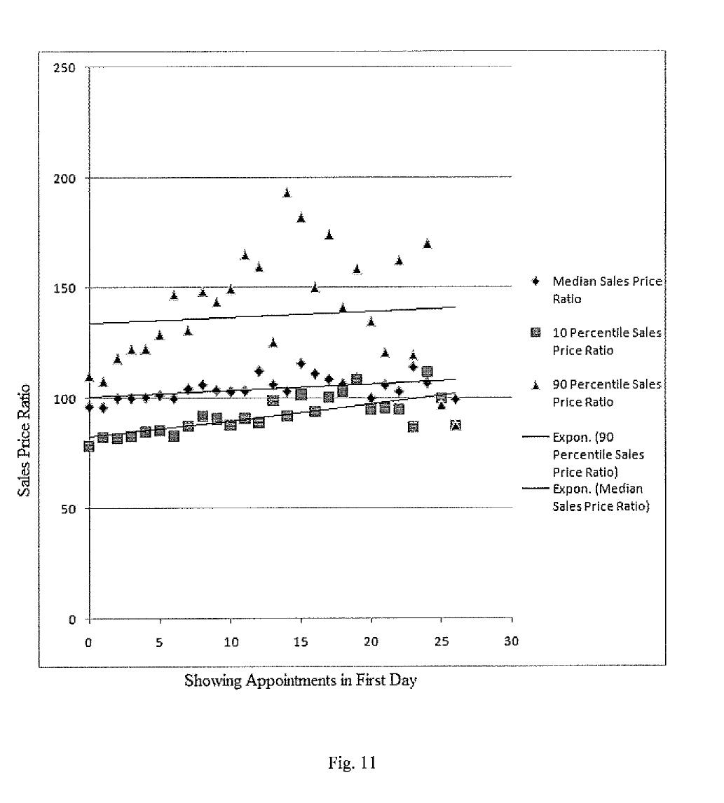

FIG. 11 is an additional graph of the data from the table of FIG. 9 depicting the number of viewings that a property received within the first day versus the median sales price ratio, as well as the 10% of properties that received the lowest price relative to their listing price, and the 10% of properties that received the highest price relative to their listing price.

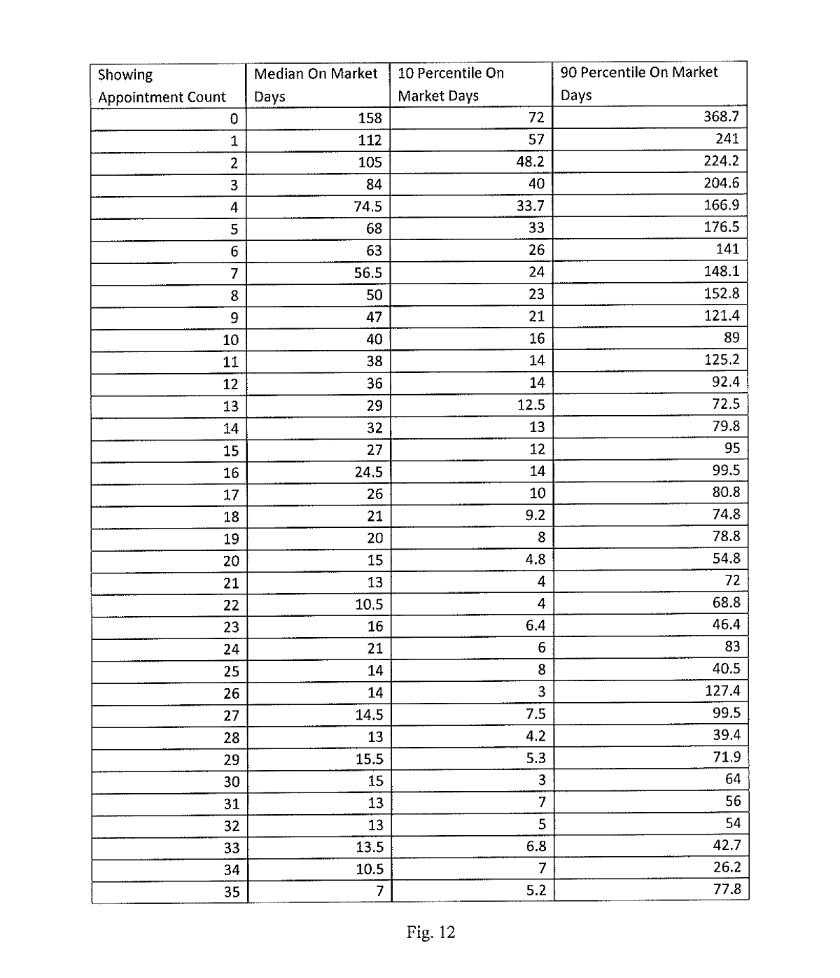

FIG. 12 depicts a table relating the number of showings that a property receives within the first seven days of its listing to the expected number of on-market days. Looking at the data table in more detail, a newly listed property that experiences 3 viewings within the first seven days of its listing can expect a median on-market time of 84 days, although the sales time for the 10% of properties that experienced a similar number of viewings and sold most rapidly was 40 days, and the sales time for the 10% of properties that experienced a similar number of viewings and required the most time to sell was 204.6 days. Contrast this with a property that experienced 20 viewings within the first seven days; the median sales time was only 15 days, while the 10% time was 4.8 days, and the 90% time was 54.8 days.

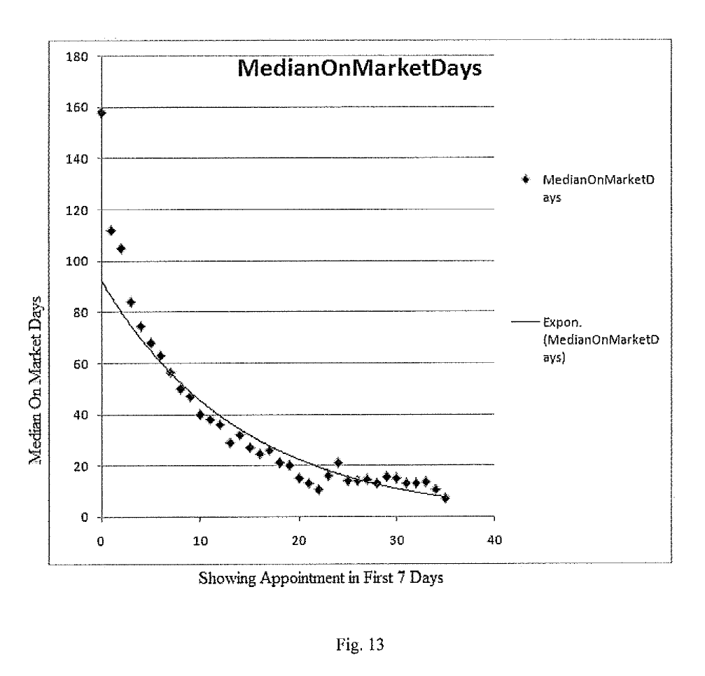

FIG. 13 is a graph using the data from the table of FIG. 12 depicting the number of viewings that a property received within the first seven days versus the median on-market days that a property required to sell. Given the greater sampling period, the data is more tightly correlated, as can be expected, than that which was used for projections based on the number of viewings within the first day of listing.

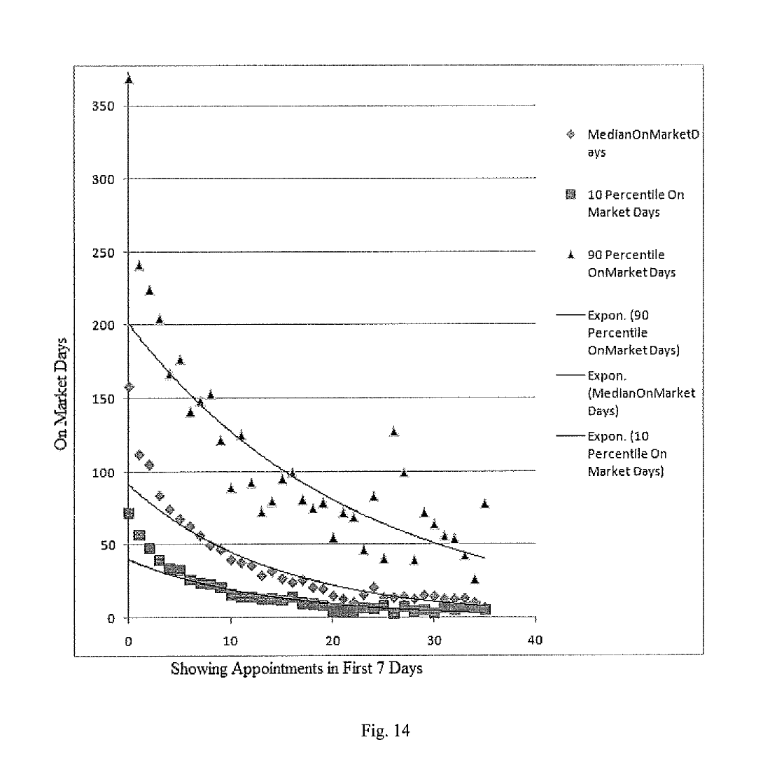

FIG. 14 is an additional graph of the data from the table of FIG. 12 depicting the number of viewings that a property received within the seven days versus the median on-market days as well as the 10% of properties that sold in the least number of on-market days and experienced a similar number of viewings within seven days of listing as the newly listed property, and the 10% of properties that took the longest to sell and experienced a similar number of viewings within seven days as the newly listed property.

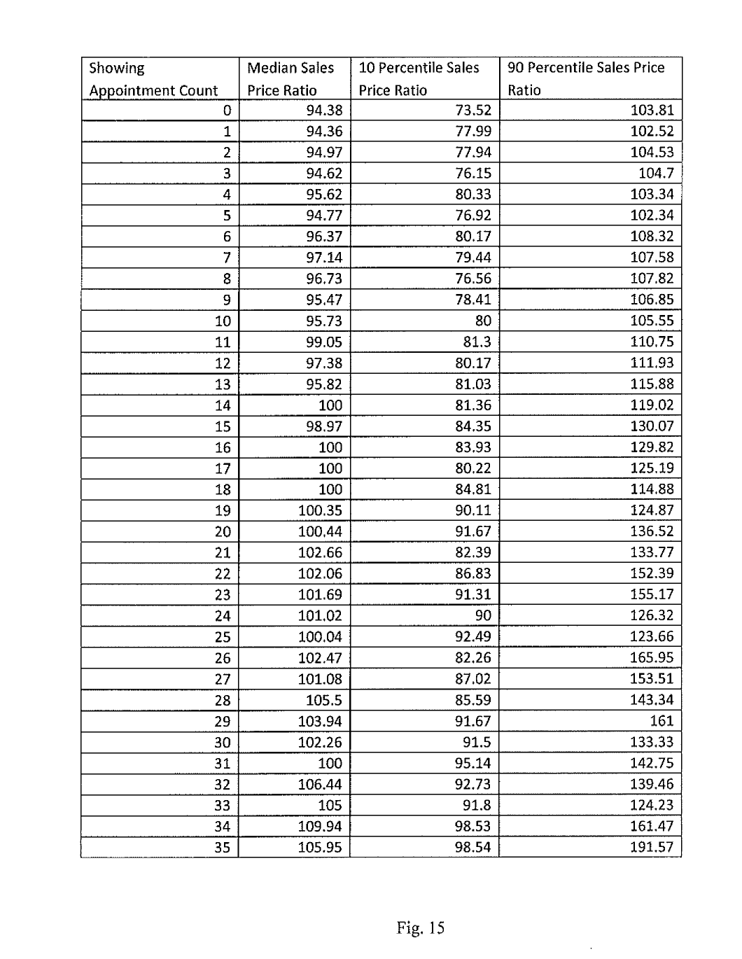

FIG. 15 depicts a data table relating the number of viewings that a model set of properties received within the first seven days after their listing to the eventual sales price ratio that the model set properties received. Examining the data within the data table in detail, the leftmost column shows the number of showings that a group of properties within the model set received within seven days of their listing. The second column shows the median sales price ratio, which is the statistical median of the ratio of the actual sales price to the price that the property was initially listed at. The third column shows the price ratio of those properties with the number of viewings within seven days of their listing reflected in the first column that sold for the less than 90% of similar properties relative to their listing price (“10% sales price ratio”) while the last column shows similar properties that sold for the most relative to 90% of similar properties relative to their listing price (“90% sales price ratio”).

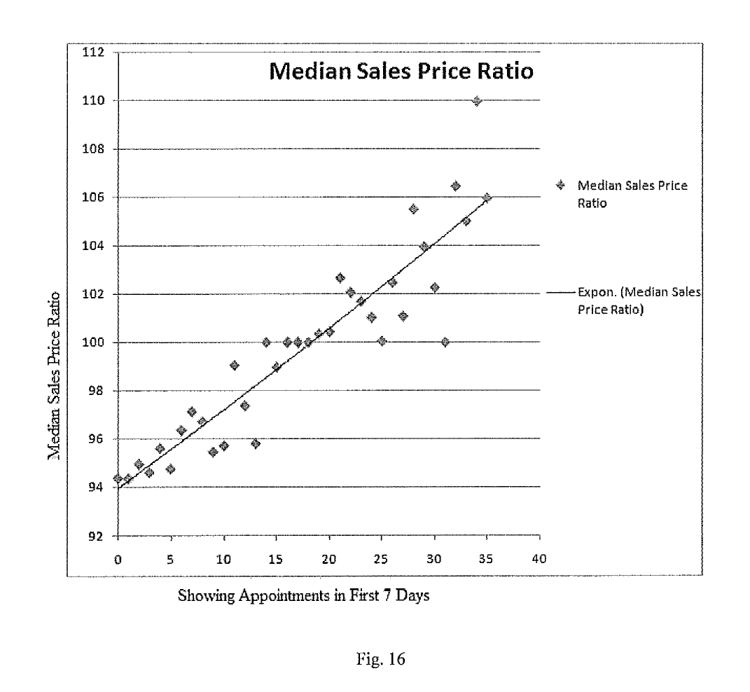

FIG. 16 is a graph using the data from the table of FIG. 37 depicting the number of viewings that a property received within the first seven days versus the median sales price ratio that a property received when it sold. As can be seen, the number of viewings is predictive of the sales price ratio that a property will receive, and, accordingly, a newly listed property similar to the properties that comprised the model set used to create the data of table 37 that received 20 viewings within seven days of being listed can be expected to sell for slightly more than 100% of its listing price.

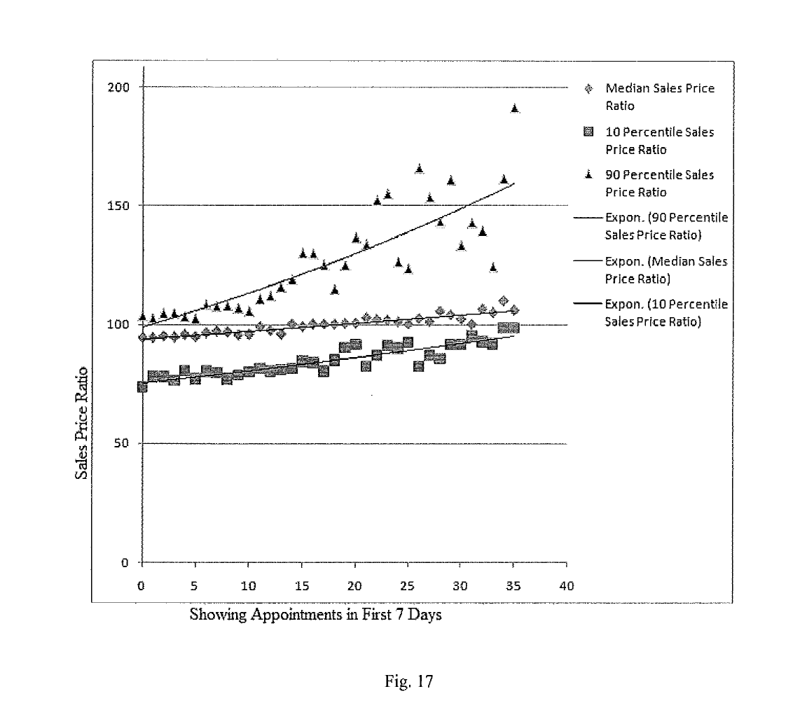

FIG. 17 is an additional graph constructed using the data of FIG. 37. In addition to the median sales price ratio, this graph also depicts the 10% sales price ratio and the 90% sales price. As with other graphs, an exponential trend line is used to make a best fit estimate and account for data that is slightly outside of expected ranges.

Persons of skill in the art will understand that this invention can be extended to other embodiments than those specifically disclosed herein. For example, while the disclosed invention was generally discussed in terms of predicting the sales price and time to sell residential properties, the systems and methods disclosed herein can be extended to apply to commercial sales, industrial sales, property leases and other real estate markets.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method of estimating the number of days that a real property is likely to be listed before a transaction occurs, said real property being listed at a particular price, and having been viewed a measured number of times within a predetermined time period after being listed, the method comprising the steps of:
accessing a listing and sales database containing a plurality of real property listings and transaction information for those real property listings, the transaction information including the number of days that a property was listed before a transaction occurred, and the number of times that a property was viewed within a predetermined time period after it was listed;
deriving a model relating the number of times that a property was viewed within said predetermined time period after it was listed to the number of days that it was listed prior to a transaction occurring; and
predicting the number of days that said listed property will be listed prior to a transaction occurring using said model and the measured number of times that said property was viewed within said predetermined time period after being listed.

2. The method of claim 1 wherein the step of deriving a model comprises a best fit exponential, and other regression methods, trendline analysis.

3. The method of claim 1 further comprising the step of accessing a web site access database relating a plurality of property web sites to a number of accesses for each of the plurality of property web sites, wherein said plurality of property web sites correspond to at least some of said plurality of real property listings, and wherein the step of deriving a model includes relating the number of times that a property web site was accessed to the number of days that a property was listed before a transaction occurred.

4. The method of claim 3 wherein a website is associated with said listed property and wherein said web site access database includes an entry relating a number of times that said listed property website was accessed within said predetermined time period after said listed property was listed, and wherein said step of predicting uses the number of times that said listed property website was accessed within said predetermined time period.

5. The method of claim 1 further comprising the step of accessing a lockbox access database relating a plurality of lockboxes to a number of accesses for each lockbox, wherein said plurality of lockboxes correspond to at least some of said plurality of real property listings, and wherein the step of deriving a model includes relating the number of times that a property lockbox was accessed to the number of days that a property was listed before a transaction occurred.

6. The method of claim 5 wherein a lockbox is associated with said listed property and wherein said lockbox access database includes an entry relating a number of times that said lockbox associated with said listed property was accessed within said predetermined time period after said listed property was listed, and wherein said step of predicting uses the number of times that said listed property website was accessed within said predetermined time period.

7. The method of claim 1 further comprising the step of accessing a key kiosk database, said key kiosk database including entries for one or more key kiosks, each of said entries relating a plurality of real properties to a number of key accesses, wherein said plurality of real properties correspond to at least some of said plurality of real property listings, and wherein the step of deriving a model includes relating the number of times that a key was accessed to the number of days that a property was listed before a transaction occurred.

8. The method of claim 7 wherein a key is associated with said listed property and wherein said key kiosk database includes an entry relating a number of times that said key associated with listed property was accessed within said predetermined time period after said listed property was listed, and wherein said step of predicting uses the number of times that said listed property key was accessed within said predetermined time period.

9. A method of estimating a percent of a listing price that a real property is likely to be sold at, said real property having been viewed a measured number of times within a predetermined time period after being listed, the method comprising the steps of:
accessing a listing and sales database containing a plurality of real property listings and transaction information for those real property listings, the transaction information including a listing price, a sales price, and a number of times that a property was viewed within a predetermined time period after it was listed;
deriving a model relating the number of times that a property was viewed within said predetermined time period after it was listed to the ratio of the sales price to the listing price; and
predicting a ratio of sales price to listing price for said listed property using said model and the measured number of times that said property was viewed within said predetermined time period after being listed.
